(19) United States
(12) Patent Application Publication
(10) Pub. No.: US 2016/0076937 A1
(43) Pub. Date: Mar. 17, 2016

(54) DISPLAY OF IMAGES FROM AN IMAGING TOOL EMBEDDED OR ATTACHED TO A TEST AND MEASUREMENT TOOL

(71) Applicant: Fluke Corporation, Everett, WA (US)

(72) Inventors: Michael D. Stuart, Issaquah, WA (US); Paul H. Heydron, Everett, WA (US); Terry G. Morey, Renton, WA (US)

(21) Appl. No.: 14/855,989

(22) Filed: Sep. 16, 2015

Related U.S. Application Data
(60) Provisional application No. 62/051,938, filed on Sep. 17, 2014.
(60) Provisional application No. 62/051,914, filed on Sep. 17, 2014.

(51) Int. Cl. G01J 1/44; G06F 1/16

(52) U.S. Cl. CPC G01J 1/44; G06F 1/163

(57) ABSTRACT

Systems include a test and measurement tool configured to acquire measurement data representative of at least one parameter of a device under test, an imaging tool configured to acquire image data representative of a target scene, and a display device. The display device can include a display and can be in communication with the test and measurement tool and the imaging tool. The display device can receive measurement data from the test and measurement tool and image data from the imaging tool, and present a display representative of at least one of the measurement data and the image data on the display.

### CROSS-REFERENCES

This application claims the benefit of U.S. Provisional Application No. 62/051,938, filed Sep. 17, 2014, and U.S. Provisional Application No. 62/051,914, filed Sep. 17, 2014, the content of which is hereby incorporated by reference in its entirety.

### BACKGROUND

Various information regarding parameters of system components may be useful in analyzing individual component's performance, operating conditions, lifespan, and other various aspects. Some such information includes measurable quantities, such as a current, voltage, power, impedance, vibration, and the like. Analysis of components of a system may provide insight into ways the system may be improved, for example, by repairing or replacing faulty or otherwise non-optimal components. Various test and measurement tools are capable of performing such measurements, and are often used in analyzing such components.

In some examples, additional information may be helpful in analyzing such components. For example, imaging techniques, such as infrared imaging, may provide useful additional information. Infrared imagery of a system or components thereof can provide thermal patterns of the scene, highlighting temperature abnormalities in system components. Such imagery may be useful in diagnosing similar or different issues that may be detected or otherwise analyzed using standard test and measurement tools as discussed above.

In order to take advantage of the benefits of measurements using various test and measurement tools and also infrared imagery, a user set to analyze the system must often carry several pieces of equipment for performing desired analysis. In addition, the user must take care to ensure that any recorded measurement data (e.g., from one or more test and measurement tools) is associated with the appropriate equipment and correlated to other measurement data from other test tools. However, in some instances, neither the test and measurement tool nor the imaging tool comprises a display suitable for presenting both image data and measurement data, making it difficult for a user to take advantage of using both sets of data.

### SUMMARY

Embodiments of the invention are directed to systems and methods for acquiring and displaying measurement data and image data. Exemplary systems include a test and measurement tool configured to acquire measurement data representative of at least one parameter of a device under test and an imaging tool configured to acquire image data representative of a target scene. Systems can include a display device comprising a display and in communication with the test and measurement tool and the imaging tool. The display device can be configured to receive measurement data from the measurement tool and to receive image data from the imaging tool. In some examples, the display device can be configured to generate and/or present a display representative of at least one of the measurement data or image data on the display.

The display device can be in wired or wireless communication with one or both of the imaging tool and the test and measurement tool. In some embodiments, the display device is capable of processing one or both of the measurement data and the image data for generating a display for presentation. For instance, display devices can include a smart device such as a tablet, smartphone, wearable device, and the like capable of performing various processing operations on received data. In some examples, one or both of the imaging tool and the test and measurement tool can be integrated into a common device with the display device.

### BRIEF DESCRIPTION OF THE DRAWINGS

FIGS. 1A-D are views of exemplary systems including a test and measurement tool, an imaging tool, and exemplary external devices.

FIG. 2 is an exemplary schematic diagram of a test and measurement tool comprising a variety of components.

FIG. 3 shows an example block diagram of an imaging tool configured for receiving electromagnetic radiation according to some exemplary systems.

FIG. 4 is an exemplary diagram illustrating communication between various system components.

FIG. 5 is an exemplary illustration of eyewear embodied as safety glasses.

FIGS. 6A and 6B illustrate another embodiment of eyewear.

FIG. 7 is an exemplary display showing combined image and measurement data.

### DETAILED DESCRIPTION

Embodiments of the invention generally relate to methods and devices for combining imaging tools, such as cameras or other optical systems, with various test and measurement tools. Exemplary test and measurement tools can include, but are not limited to, digital multimeters, current measurement tools, power quality tools, vibration tools, portable oscilloscope tools, laser alignment tools, ultrasonic test tools, insulation resistance testers, multi-function electrical test tools, single-function electrical test tools, contact temperature measurement tools, humidity measurement tools, air-flow measurement tools, air temperature measurement tools, air quality and particulate measurement tools, and the like.

In some examples, a test and measurement tool can interface with an imaging tool. In various embodiments, the imaging tool can be embedded into the test and measurement tool, or can be attached to the test and measurement tool as an accessory. The test and measurement tool can communicate with the imaging tool via a wired or wireless connection (e.g., radio frequency (RF) communication, infrared (IR) communication, serial communication, WIFI, Zigbee, Bluetooth, etc.). Exemplary imaging tools can include sensors (e.g., sensor arrays) sensitive to any number of a range of wavelengths, including visible light (VL), near infrared (NIR), short wavelength infrared (SWIR), long wavelength infrared (LWIR), terahertz (THz), ultraviolet (UV), or other wavelengths. In some examples, the imaging tool interfacing with a test and measurement tool can include a plurality of cameras, sensors, optical systems, and the like. For instance, in some examples, an imaging tool can include both an infrared (IR) and a visible light (VL) sensors for detecting both IR and VL radiation, as generally described in U.S. Pat. No. 7,535,002, entitled “CAMERA WITH VISIBLE LIGHT AND INFRARED BLENDING,” which is assigned to the assignee of the instant application, and which is hereby incorporated by reference in its entirety.

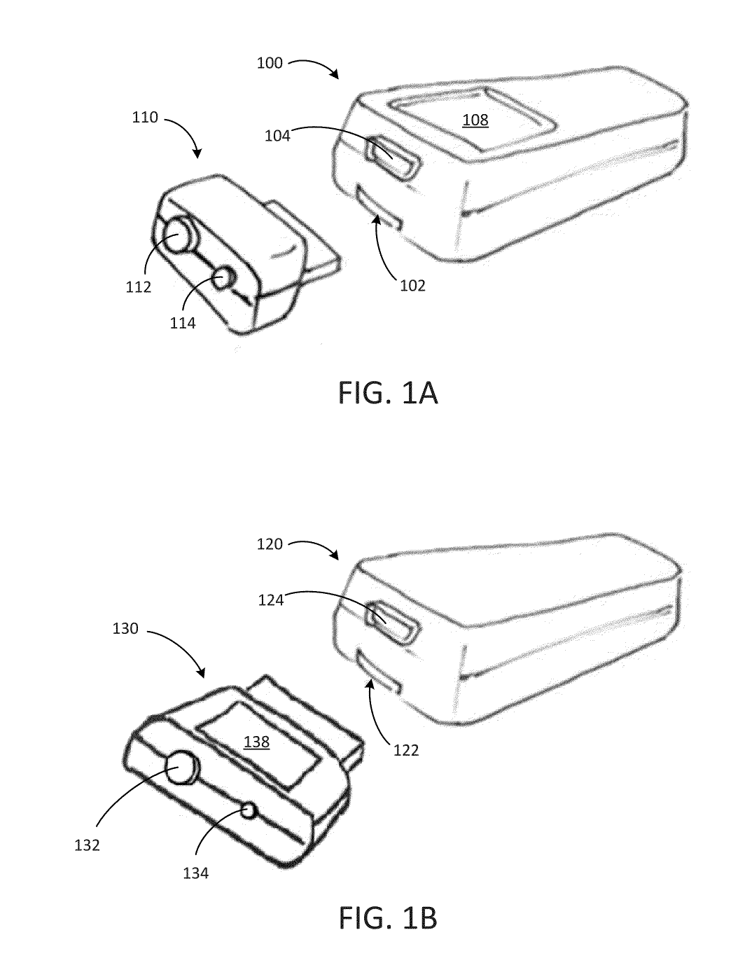

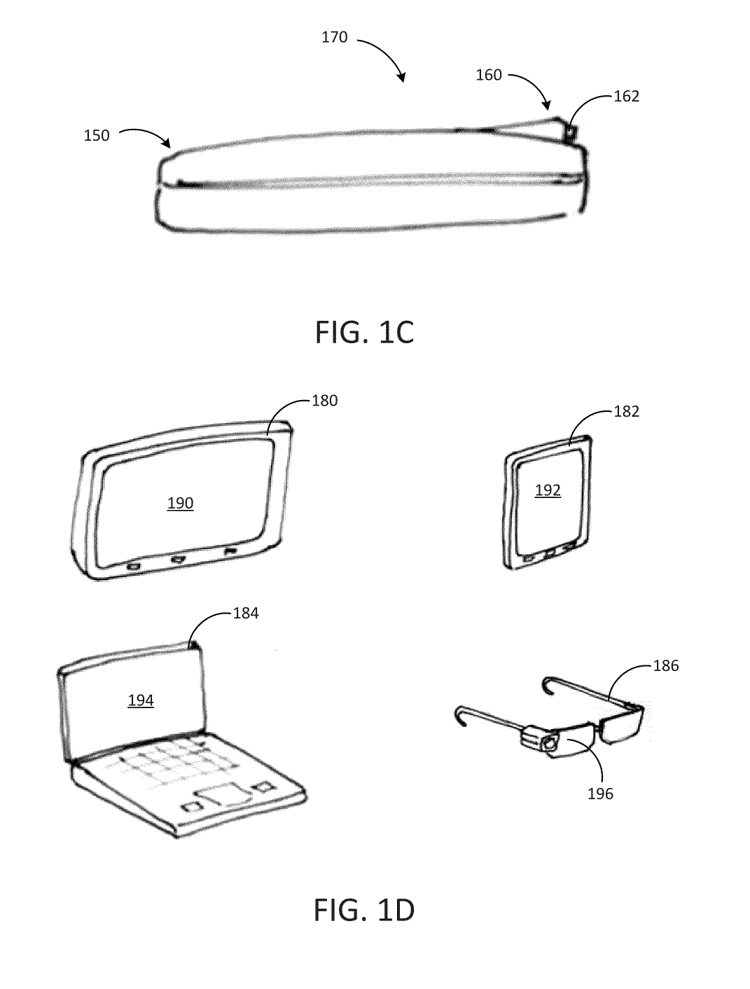

FIG. 1A is a view of an exemplary system including a test and measurement tool and an imaging tool. FIG. 1A includes a test and measurement tool 100 and an imaging tool 110. The test and measurement tool 100 can be configured to generate measurement data representative of at least one parameter of an object under test. In the illustrated examples, test and measurement tool 100 includes a display 108. In some examples, display 108 may be used for presenting information, such as measurement data, for observation by a user.

The illustrated imaging tool 110 includes an infrared (IR) camera 112 and a visible light (VL) camera 114, though it will be appreciated that various imaging tools such as 110 can include any combination of appropriate sensors capable of detecting a variety of wavelengths. In some embodiments, the test and measurement tool 100 can removably receive the imaging tool 110 at a receiving portion 102 of the test and measurement tool 100. In various embodiments, the imaging tool 110 can be secured to the test and measurement tool 100 in any number of ways, for example, via a press fit, snap fit, clip, magnet, hook and loop fastener, or the like.

In some examples, the test and measurement tool 100 can include a communication port 104 for communicating with the imaging tool 110. In various embodiments, communication port 104 can communicate with the imaging tool 110 when the imaging tool 110 is received by the test and measurement tool 100, such as via a physical connection. In some examples, the communication port 104 is capable of wireless communication such that the test and measurement tool 100 may communicate with the imaging tool 110 when the imaging tool 110 is separate from the test and measurement tool 100. Communication port 104 can facilitate any known form of communication between the imaging tool 110 and the test and measurement tool 100, including wired or wireless communication (e.g., radio frequency (RF) communication, infrared (IR) communication, serial communication, WIFI, Zigbee, Bluetooth, etc.). In some embodiments, communication port 104 provides two-way communication between the test and measurement tool 100 and the imaging tool 110.

In some examples, communication port 104 is positioned proximate a receiving portion 102 of the test and measurement tool 100. In some such embodiments, the imaging tool 110 may be attached to the receiving portion 102 of the test and measurement tool 100 and engage the communication port 104 of the test and measurement tool 100. Thus, the imaging tool 110 may be capable of communicating with the test and measurement tool 100 when received at the receiving portion 102 thereof. In some examples, communication between the imaging tool 110 and the test and measurement tool 100 via communication port 104 may be automatically initiated upon attaching the imaging tool 110 to the receiving portion 102 of the test and measurement tool 100.

During exemplary operation of a system such as that in FIG. 1A, the imaging tool 110 includes an IR 112 and a VL 114 camera and is positioned proximate to or separate from the test and measurement tool 100 and proximate an object under test such that the object is within the field of view of at least one of the cameras 112, 114. The test and measurement tool 100 can be configured to measure at least one parameter related to the object under test, such as a current flowing through the object. The test and measurement tool 100 can measure the at least one parameter while the imaging tool 110 captures image data of the object under test.

The test and measurement tool 100 and imaging tool 110 can be in communication to share data, such as via communication port 104. For instance, in some examples, display 108 of the test and measurement tool 100 is capable of displaying image information. In some such embodiments, the imaging tool 110 can communicate received image data to the test and measurement tool 100 for presentation on the display 108 of the test and measurement tool 100. Communication can be accomplished via, for example, IR communication (e.g., IrDA), Bluetooth communication, or other appropriate wired or wireless data transmission. Resultantly, a combined display of image data and the at least one parameter can be presented on the test and measurement tool 100.

FIG. 1B is a view of an alternative system. Similar to FIG. 1A, the system of FIG. 1B includes a test and measurement tool 120 and an imaging tool 130. Imaging tool 130 includes an IR camera 132 and a VL camera 134. test and measurement tool 120 includes a receiving portion 122 and a communication port 124 for interfacing with the imaging tool 130 in similar ways described above regarding test and measurement tool 100 and imaging tool 110. In the example of FIG. 1B, imaging tool 130 includes a display 138. Display 138 may be capable of displaying image data from imaging tool 130, measurement data from test and measurement tool 120, or other information, such as system information or settings, for example. For example, in some embodiments, imaging tool 130 can receive measurement data from the test and measurement tool via communication port 104, and display one or both of image data and measurement data on display 138.

FIG. 1C is a view of yet another system. In the example of FIG. 1C, imaging tool 150 is integrated into test and measurement tool 140. That is, the system of FIG. 1C shows a combination tool 170 having integral test and measurement tool 140 and imaging tool 150. Imaging tool 160 includes a camera 162 capable of detecting radiation in one or more ranges of wavelengths. Imaging tool 160 may include a plurality of cameras for detecting radiation in different wavelength spectrums. In some examples, the imaging tool may include a plurality of sensor arrays, each sensor array sensitive to a different range of wavelengths. Some such embodiments include optics for separating light incident to imaging tool and substantially directing light within certain wavelength ranges to corresponding sensor arrays.

The combination tool 170 of FIG. 1C may be configured to generate image data and measurement data substantially simultaneously. In some examples, combination tool 170 includes a display (not shown) capable of presenting one or more of image data, measurement data, or other information. However, in some examples, the combination tool 170 is not capable of displaying all of the information generated by the test and measurement tool 150. For example, in some embodiments, combination tool 170 lacks processing capabilities (e.g., processing power, instructions, etc.) for combining measurement data and image data. Additionally or alternatively, the display of the combination tool 170 is not capable of displaying image data (e.g., images, video, false color images produced by IR or UV cameras, etc.) generated by the imaging tool. In some examples, combination tool 170 may include a display configured for displaying measurement data, but that is insufficient for properly displaying image data. For example, the display may lack the ability to display color or grayscale image representations, or may lack the resolution necessary to display a useful image. Additionally or alternatively, the combination tool 170 may not have the necessary battery or power capabilities to support a sustained display of image data without severely depleting the available stored power of the overall system.

Similarly, in some embodiments including separable or separate test and measurement tools and imaging tools, displays on one or both of test and measurement tools and imaging tools are not properly equipped for fully displaying image data. For example, many test and measurement tools do not have displays capable of displaying image data (e.g., images, video, false color images produced by IR or UV cameras, etc.) generated by cameras or other optical systems or components. For example, some such test and measurement tools may include a display configured for displaying measurement data, but are insufficient for properly displaying image data. Additionally or alternatively, test and measurement tools may not have the necessary battery or power capabilities to support a sustained display of image data without severely depleting the available stored power of the overall system.

In some instances, one or both of the test and measurement tool can include a communication tool, such as a wireless radio, for transmitting data to another device capable of displaying data or other information. Communication tool can the same as or separate from a communication port (e.g., 104) facilitating communication between the test and measurement tool and the imaging tool. The communication tool can be included any one or more of a test and measurement tool, an imaging tool, and a combination tool. For example, in some embodiments, the test and measurement tool can communicate with an associated imaging tool to receive image data, and transmit the received image data to an external device. In some examples, the test and measurement tool can transmit both image data and measurement data acquired by the test and measurement tool to the external device. Similarly, in some examples, the test and measurement tool may communicate measurement data to an associated imaging tool, which can communicate one or both of image data and measurement data to an external device.

The external device can receive image data, measurement data, or both, and present a display to a user for analyzing the data. In some examples, the external device can combine the image data and the measurement data as described in U.S. Patent Publication No. US20140278259, corresponding to U.S. patent application Ser. No. 14/214,600, filed Mar. 14, 2014, and entitled “CAPTURE AND ASSOCIATION OF MEASUREMENT DATA,” which is assigned to the assignee of the instant application and is hereby incorporated by reference in its entirety. Exemplary external devices capable of communication with a test and measurement tool for receiving and displaying one or both of measurement and image data can include, but are not limited to, smartphones, tablets, smart glasses or other wearable devices, and computers.

In some examples, external device is a display device including a display for presenting one or both of image data and measurement data. FIG. 1D is a series of exemplary external devices comprising displays for presenting one or both of image data and measurement data. As shown, an external device in communication with any one of an imaging tool, a test and measurement tool, or a combination tool can include a tablet 180, a smartphone 182, a computer 184 (e.g., a laptop, desktop, or the like), or a wearable device, such as smart glasses 186. Each external device includes a display (190, 192, 194, 196, respectively) capable of visually presenting information to a user. Accordingly, each exemplary external device may receive and subsequently display any one or more of image data and measurement data. Any combination of tools and external devices are possible. For example, any one of an imaging tool, a test and measurement tool, or a combination tool can include a communication tool capable of communicating any one or more of image data and measurement data to any one or more of a tablet 180, smartphone 182, computer 182, wearable technology 186, or other external device.

In the illustrated embodiment, external devices include displays (e.g., 190, 192, 194, 196) which may be used to present the acquired data. In some examples, external device includes a processor capable of generating a display from acquired measurement data and/or image data. For instance, external device may include instructions programmed into a non-transitory computer-readable medium instructing a processor to generate a display including one or both of image data and measurement data. In some such examples, the processor may combine image data and measurement data for simultaneous presentation on a signal display. In other examples, one or both of the test and measurement tool and the imaging tool is capable of processing data, including combining measurement and image data, prior to communicating the data to an external device. In some embodiments, aspects of the display, such as the information included in the display, image data palettization schemes, locations of various display features, and the like can be adjusted by a user via a user interface on at least one of the imaging tool, the test and measurement tool, or the external device.

In general, one or both of image data from the imaging tool and measurement data from the test and measurement tool can be presented for display on a display device. The display device can include any device having a display and capable of presenting such information. For example, in some embodiments, the display device includes an external device as described above, capable of receiving and presenting one or both of image data and measurement data. Additionally or alternatively, the display device can be included in any one of the imaging tool, test and measurement tool, or a combination tool.

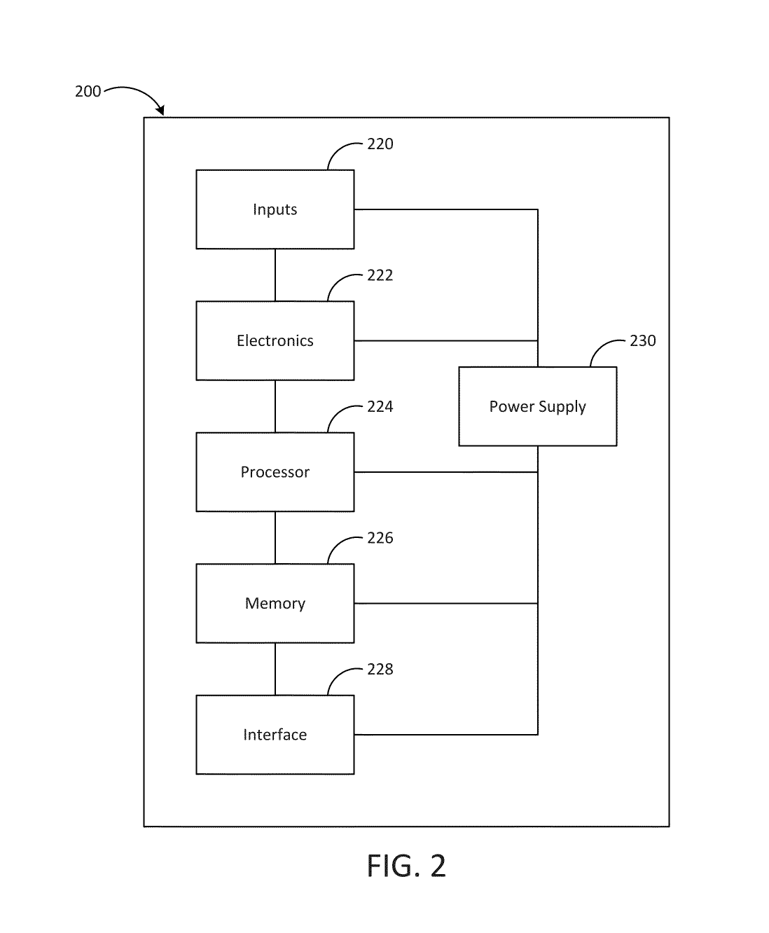

FIG. 2 is an exemplary schematic diagram of a test and measurement tool comprising a variety of components. In the illustrated example, the test and measurement tool 200 may include one or power supplies 230 for providing electrical power to any of a variety of system components for performing a variety of tasks, such a performing one or more primary functions. In some embodiments, the one or more power supplies 230 may include one or more batteries. Additionally or alternatively, the test and measurement tool 200 may be capable of running on AC power, e.g., from a standard wall receptacle. In some such embodiments, one or more batteries of the test and measurement tool 200 may be charged while the tool 200 is operating on or otherwise plugged into an AC power source.

The test and measurement tool may include one or more inputs 220 configured to interface with an object under test for performing a measurement of a parameter thereof. In various examples, the one or more inputs 220 may include any appropriate input for performing a measurement of a parameter of a device under test. The one or more inputs 220 may provide a signal indicative the parameter of the object under test to any combination of electronics 222 and a processor 224 for further processing of the signal. In some examples, the test and measurement tool 200 includes a memory 226 for storing information indicative of one or more parameters of a device under test.

In some embodiments, test and measurement tool 200 may include an interface 228 for interacting with a user. In some examples, interface 228 may include one or more controls for receiving user inputs. Controls may include, for example, buttons, switches, knobs, touch screens, etc. In some embodiments, a user may initiate a measurement or other test and measurement tool 200 function using controls. Additionally or alternatively, the interface may include a display for communicating information to a user. For example, the display may present a user with selectable options, such as various functions selectable by the user via controls. Additionally or alternatively, the display may be configured to present the results of one or more measurements performed by the test and measurement tool for observation by a user. In some examples, a display is capable of presenting textual measurement information (e.g., letters, numbers, etc.), but is not capable of displaying image information, such as described elsewhere herein. Additionally or alternatively, in some embodiments, power supply 230 is not capable of supporting a continuous image display without severely depleting the available power supply. Thus, in some examples, presentation of image data via interface 228 may be impossible or impractical.

In some examples, interface 228 may provide an interface with additional equipment. For example, in some embodiments, interface 228 can provide a communication interface between the test and measurement tool 200 and an imaging tool (e.g., 110) or an external device (e.g., smartphone, tablet, etc.). In various embodiments, interface 228 can be used to export received measurement data, such as from inputs 220, or a processed result, for example, from processor 224.

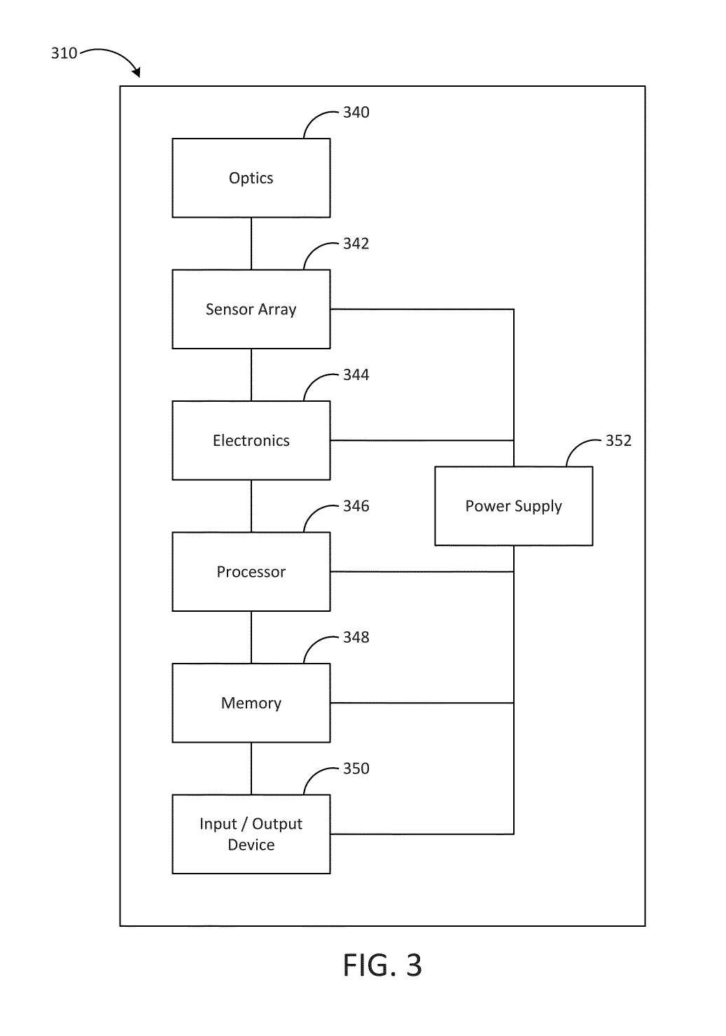

FIG. 3 shows an example block diagram of an imaging tool configured for receiving electromagnetic radiation according to some exemplary systems. In the illustrated embodiment, imaging tool 310 includes optics 340, a sensor array 342, electronics 344, one or more processors 346, memory units 348, input/output devices 350, and a power supply 352.

The optics 340 can include optics for focusing, deflecting, and/or reflecting electromagnetic radiation from a target object onto the sensor array 342. In some examples, the sensor array 342 may include an infrared sensor array sensitive to infrared radiation. An imaging tool including such an infrared sensor array may be used to make non-contact temperature measurements.

In such embodiments, the infrared sensor array 342 can include one or more thermal detectors such as microbolometers or thermopiles, or could be composed of photon detectors such as photodiodes or phototransistors, or other thermal or photon detection device. In some examples, an infrared sensor array may include a single detector, for instance, for determining a spot temperature within a target scene. Alternatively, an infrared sensor array may comprise a plurality of such detectors for acquiring one or both of a spot temperature (e.g., via an average value of sensor array sensors) and a two-dimensional infrared image.

One of skill in the art will recognize that various sensor arrays (e.g. photon sensor arrays) can be used, and can be used in combination with one or more infrared sensor arrays. In some examples, the sensor array is fixed within the imaging tool 310 to provide a more durable device having fewer moving and moveable parts. In various examples, the size and positioning of the detector depends on the characteristics of the optical system (e.g., the relationship between optics 340 and sensor array 342). In some embodiments, the detector is generally circular having a diameter of 0.5 mm to 3 mm. However detectors of any size and shape should be considered within the scope of the invention. The detector produces a signal as a function of the radiation or other scene data imaged thereupon. These signals can be processed by known methods to indicate a temperature or other metric indicated via the received radiation.

A person of skill in the art will recognize that many materials and materials technologies may be suitable for use in an infrared sensor array. In some examples, the infrared sensor array 342 responds to infrared radiation ranging from approximately 0.7 microns to approximately 30 microns and can have a peak sensitivity within this range. The electronics 344 receive the output signals from the sensor array 342 and pass them to the processor 346 for analysis.

When an infrared sensor assembly is used, the processor 346 can be used to run infrared thermometer applications including, but not limited to, deciding if the target object sufficiently fills the field of view, and averaging output signals for a period of time to reduce the impact of noisy measurements on the accuracy of the measured temperature. In the case of alternative sensor arrays (e.g., sensitive to one or more of visible light, ultraviolet light, X-rays, etc.), the processor 346 may be used to run corresponding imaging applications.

Memory 348 can include but is not limited to, RAM, ROM, and any combination of volatile and non-volatile memory. A power supply 352 can include, but is not limited to, a battery, a parasitic energy system (e.g., an inductive system), and components for directly receiving AC power. The power supply 352 can provide power to the sensor array 342, electronics 344, processor 346, memory 348, and/or input/output devices 350. An input/output device 350 can include, but is not limited to, triggers to start and stop the image capture, visual displays, speakers, and communication devices that operate through wired or wireless communications.

For instance, in some examples, the input/output device 350 of the imaging tool 310 can include a display capable of displaying an image produced from data conveyed or captured by one or more sensor arrays 342. In some examples, the display can be further configured to show other data, for instance, data from the test and measurement tool (e.g., via communication port 104) or other external sources. Additionally or alternatively, input/output device 350 may be capable of one or more of receiving measurement data from a test and measurement tool and communicating one or both of image data and received measurement data to an external device, such as a tablet, smartphone, computer, etc.

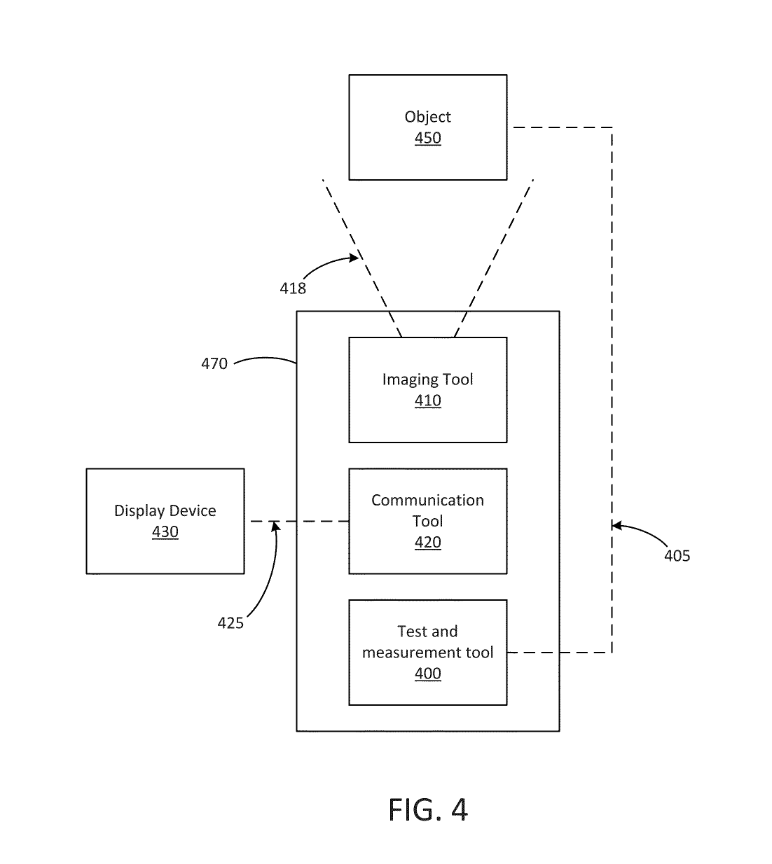

FIG. 4 is a schematic diagram illustrating exemplary operation of a system. In the illustrated embodiment, a combination tool 470 includes a test and measurement tool 400 and an imaging tool 410. In the illustrated configuration, test and measurement tool 400 is arranged to interface with object 450 via communication 405 to generate measurement data representative of at least one parameter of the object 450. The imaging tool 410 is arranged such that object 450 is in the field of view 418 of the imaging tool 410. Imaging tool 410 can be configured to generate image data representative of the object 450. In an exemplary embodiment, imaging tool 410 includes an infrared sensor array and is configured to generate infrared image data representative of the heat pattern of object 450.

The combination tool 470 includes a communication tool 420 in communication with a display device 430 via communication link 425. Communication link 425 can include a wired (e.g., fixed or detachable wired connection) or wireless connection. Display device 430 may include an external device, such as a tablet, smartphone, computer, wearable device, or the like. During operation, the communication tool 420 may receive at least one of image data from imaging tool 410 and measurement data from test and measurement tool 400. Communication tool 420 may communicate at least one of the received image data and measurement data to the display device 430 for display. As described elsewhere herein, in some examples, data communicated to display device 430 from communication tool 420 may already be processed and suitable for display. In other examples, display device 430 may process the received data in order to generate a display.

In some examples, imaging tool 410 is fixedly integrated along with the test and measurement tool 400 to form the combination tool 470. In other examples, the imaging tool 410 may be separable from the test and measurement tool 400. In some such examples, imaging tool 410 can communicate with at least one of the test and measurement tool 400 and the display device 430 via its own communication tool (not shown). Similarly, test and measurement tool 400 may communicate information to at least one of a separable imaging tool 410 and display device 430.

As described, the display device (e.g., 430) can receive image data (e.g., IR and VL image data) and measurement data (e.g., a current measurement) and generate and present a display including any or all of the received measurement and/or image data. For example, IR and VL image data can be combined for display as in U.S. Pat. No. 7,535,002, while image data and measurement data can be combined as in U.S. patent application Ser. No. 14/214,600, filed Mar. 14, 2014. The combination of image data and measurement data can be displayed to present both image streams to the user.

In some examples, the display may be supported by the same structure as one or both of the imaging tool and the test and measurement tool. For example, glasses such as 186 in FIG. 1D or other eyewear may include both display capabilities and image capturing capabilities (e.g., an imaging tool). More generally, eyewear can generally include any apparatus worn over or proximate the eye, including but not limited to glasses (e.g., eyeglasses, safety glasses, etc.), face shields, welding helmets, and arc-flash hoods and helmets. Embodiments of the eyewear with capability to embed infrared camera, visible camera, display, wireless radio, capable of receiving data streams from test and measurement tools, and other mobile and fixed devices which convey useful information for the purposes of maintenance, inspection, and analysis of industrial, commercial, electrical, mechanical, process-related, and NDT applications.

In some embodiments, the eyewear can include one or more embedded camera, sensor or optical component. In some such embodiments, the eyewear can include an infrared (IR) camera, sensor or optical component. Additionally or alternatively, the eyewear can include optical sensors capable of detecting light in any range of wavelengths, including visible, NIR, SWIR, LWIR, terahertz (THz), ultraviolet (UV), X-Ray or other wavelengths. For example, in some embodiments, the eyewear can further include a visible light (VL) camera embedded therein. Accordingly, eyewear can include one or more cameras for acquiring image data of a target scene.

Embodiments of the eyewear can include one or more wireless radio components configured to communicate with external devices. In some examples, the eyewear can transmit data received, for example, via one or more cameras to an external device for viewing or analysis. Additionally or alternatively, the eyewear can receive data from an external device. For example, the eyewear can receive images, live video, or both from separate test and measurement tools or accessories capable of transmitting such data.

Embodiments of the eyewear can be capable of connecting to an internet connection to facilitate the downloading data to the eyewear or uploading data from the eyewear. Eyewear can include memory for storing data captured or received by the embedded or external devices. Memory can include, for example, on-board flash memory. Eyewear can store downloaded data in memory or upload data from memory. In some embodiments, external devices can download stored data from the eyewear memory wirelessly (via internet or wireless radio connection) or via a wired connection.

In some examples, the eyewear can include one or more power sources for providing electrical power to eyewear components, such as embedded devices, memory, radio, etc. Exemplary power sources can include any combination of one or more traditional batteries, rechargeable batteries, a movement-based charging and power supply systems (e.g., electro-dynamo power supplies) or any other known and appropriate power sources.

Eyewear can include one or more control components for receiving control commands from a user. In some examples, eyewear can include the ability to monitor eye movements of the user to control various properties of the eyewear. For example, the user's eye motion can control any combination of display properties, one or more embedded devices, and the wireless radio. Additionally or alternatively, the eyewear can include a manually adjustable control device, such as a small electro-mechanical joystick (e.g., “eraser head” mouse on some laptop computers) or one or more push buttons employed on the eyewear to control various parameters (e.g., display, camera, wireless radio) of the eyewear.

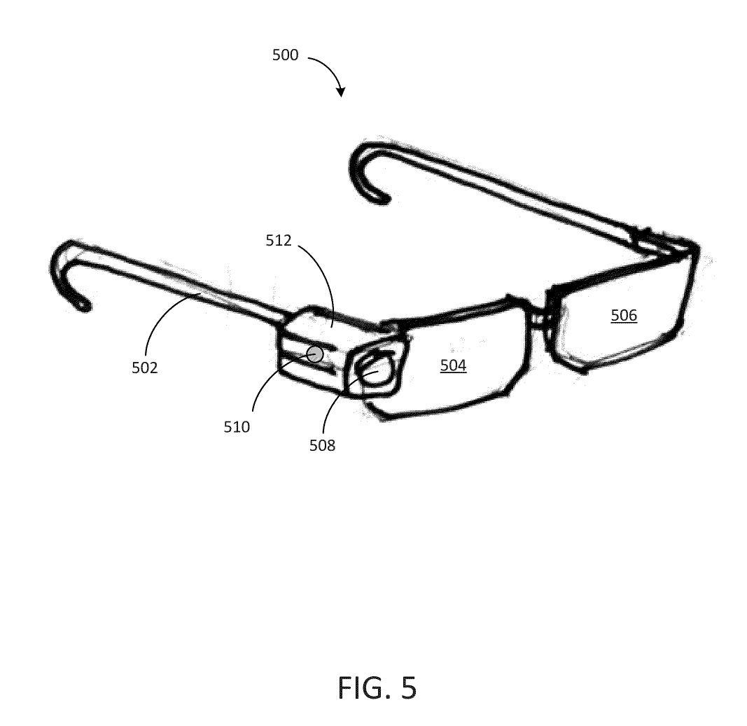

FIG. 5 is an exemplary illustration of eyewear embodied as safety glasses. Eyewear 500 includes a frame 502 and two lenses 504, 506. Lenses 504, 506 can be made of a resilient material to function as safety glasses and protect a user's eyes against hazards or debris. Lenses 504, 506 can be colored or tinted to provide further protection against other hazards such as potentially harmful wavelengths and/or intensities of light. At least one of lenses 504 and 506 can include a display ability to present a display to a wearer. In some examples, the display can substantially fill the entirety of one or both lenses 504, 506. In other examples, the display can take up only a portion of one or both lenses 504, 506 so that the wearer can more easily see surroundings beyond the eyewear 500. In some examples, the wearer can control the display mode of the eyewear.

The eyewear 500 of FIG. 5 includes an embedded camera 508. Camera 508 can be an IR camera, a VL camera, or be sensitive to any wavelength range according to optical sensors used therein. In some embodiments, eyewear can include multiple cameras, such as an IR camera and a VL camera, for imaging multiple wavelength spectra.

Eyewear 500 includes a control component 510 for the user to control operation of the eyewear. In some cases, the control component 510 can include one, both, or a combination of a joystick and one or more push buttons. The control component 510 is shown as being disposed on a housing 512. Housing 512 can include electronics for receiving input controls from the control component 510, controlling and receiving data from the camera 508, controlling a wireless radio for sending or receiving data, or to perform other tasks. Housing 512 can also include memory for storing captured images from the camera 508, programmed eyewear settings, data received from an external device, or other stored data. In some examples, housing 512 can include a display on the inside surface facing the user in order to provide a display to the user without presenting the display directly on one or both of lenses 504, 506.

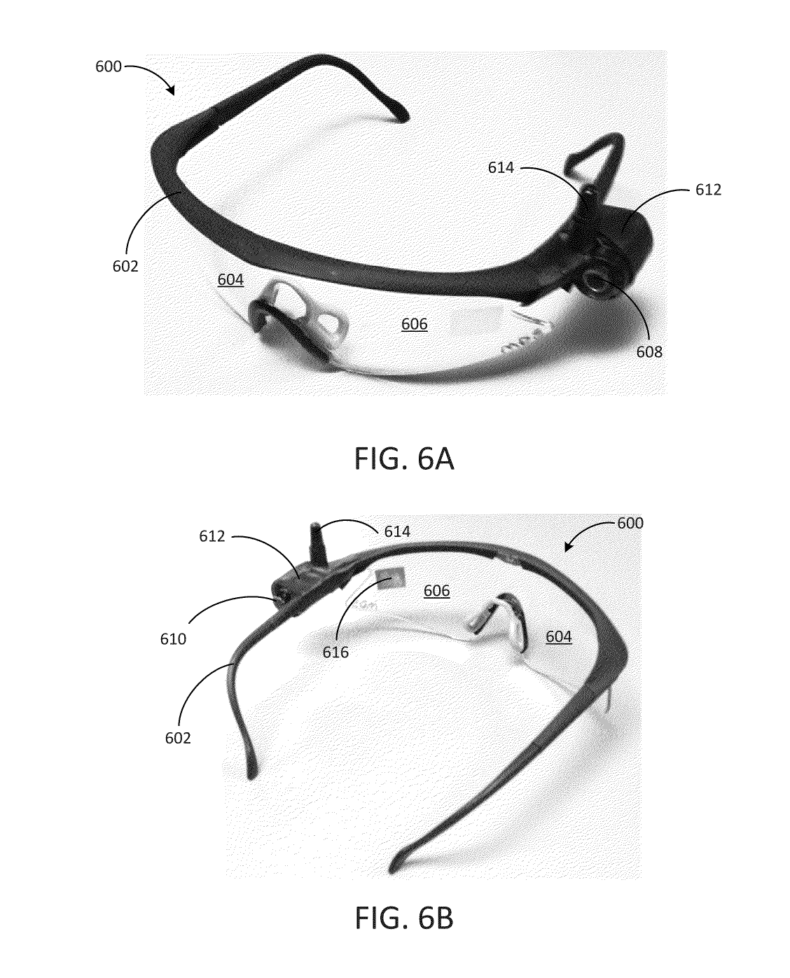

FIGS. 6A and 6B illustrate another embodiment of eyewear. FIG. 6A is a front view of a pair of safety glasses 600. Safety glasses 600 include a frame 602 and lenses 604, 606 to provide eye protection for a wearer. The safety glasses 600 include an imaging device 608 configured to generate image data of a target scene. The imaging device 608 is integrated into a housing 612, which can include electronics for interfacing therewith. The housing 612 supports a communication component 614 (e.g., an antenna) for transmitting or receiving data, for example image data generated by the imaging device or measurement data provided by an external device.

FIG. 6B is a rear view of the safety glasses of FIG. 6A. As shown, the safety glasses 600 further include a display 616 integrated into lens 606. The display 616 of FIG. 6B is configured to present one or more data streams to a wearer without filling the entire lens 606. Data for presentation on the display 616 can include any combination of image data acquired by the imaging device 608, data received via communication component 614, or any data stored in an on-board memory as described elsewhere herein. The safety glasses 600 of FIG. 6B further include a control component 610 for user control of the glasses 600. The wearer can perform various functions with the safety glasses 600 by manipulating the control component 610 as described elsewhere herein. The control component 610 as shown in FIG. 6B can include any combination of joystick and pushbutton capability.

Alternative embodiments to the glasses 500 and 600 as shown in the figures are contemplated. For example, eyewear can take the form of a full face shield, a welding helmet, or arc-flash hoods and helmets. Embodiments of eyewear can be customized to suit needs of particular uses and specific features can vary accordingly. Various embodiments have been described. Such examples are non-limiting, and do not define or limit the scope of the invention in any way. Rather, these and other examples are within the scope of the following embodiments.

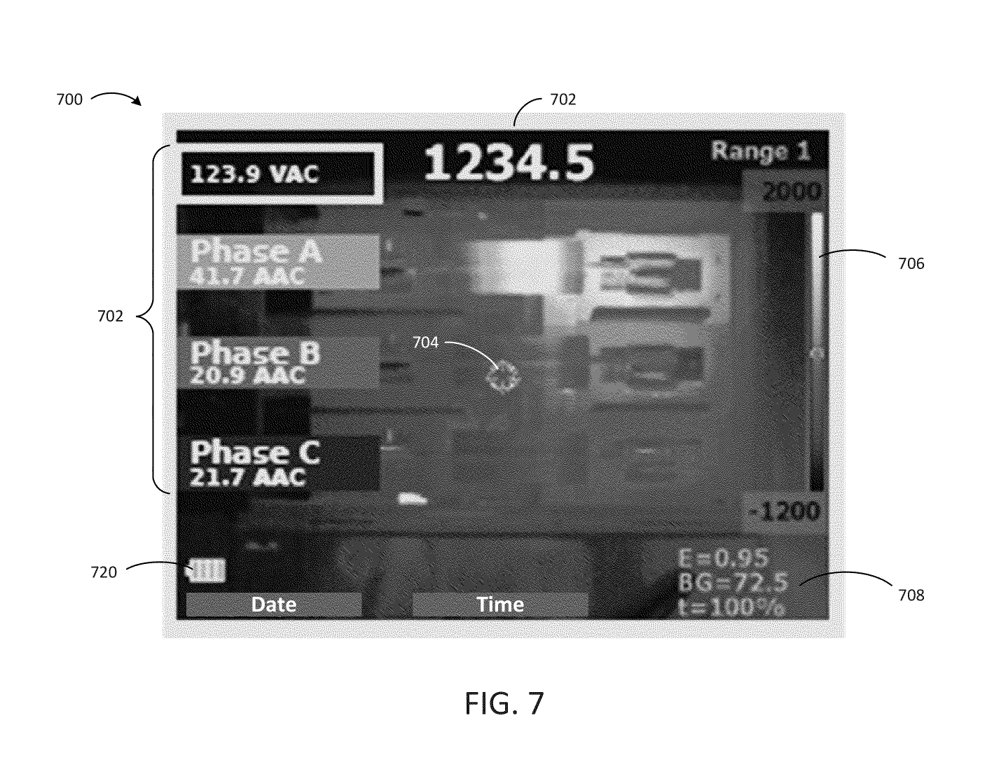

FIG. 7 is an exemplary display showing combined image and measurement data. In the illustrated example, the display 700 includes measurement data 702 comprising a measurement of current flowing through three conductors and a measured voltage. In some examples, measurement data 702 may be acquired from a single test and measurement tool capable of measuring both current and voltage. In other examples, measurement data 702 comprising both voltage and current data may be acquired from a plurality of test and measurement tools, such as a volt meter and an ammeter or other current measuring device.

In still further embodiments, known information regarding the object under test may be used to supplement measurement data. For instance, if the resistance values of the conductors of FIG. 7 are known, voltage or current measurements may be used to calculate the other. In some such examples, supplementary information such as resistance values may be stored in memory or input by a user via a user interface, for example in response to a prompt.

In the illustrated embodiment, image data presented on the display includes infrared image data representative of the thermal pattern across the scene. In the illustrated example, the display 700 includes temperature information 712 representative of the temperature of a selected spot 714 on the display. In some examples, a user may adjust the location of spot 714 for displaying a temperature of an area of interest. The display 700 includes a temperature scale 716 that associates colors within a palettized IR image to corresponding temperature values. Any appropriate palettization scheme may be used, such as grayscale, red-blue, ironbow, amber, and others. The temperature scale 716 may be used to provide an indication to a viewer of the temperature of various points in the scene without requiring the placing of spot 714 over each point.

In some embodiments, other data 718 can be included in the display. Such data can include supplementary information for the image data (e.g., an emissivity value) or the measurement data. Other information that can be displayed include battery life information 720 or information data received from one or more other devices (e.g., test and measurement tools, imaging tools, etc.) or a network such as the internet. In various examples, such data can include information from specifications, FAQs, operating instructions, and the like.

In various embodiments, at least one of the location and content of displayed data is predetermined based on which devices are in communication. For instance, in one example, any acquired data (e.g., at least one parameter from the test and measurement tool, image data from the imaging tool, etc.) can be displayed on the test and measurement tool by default. In another example, any acquired data is automatically displayed on an external device if one is in communication with at least one of the test and measurement tool and the imaging tool. In some embodiments, a user can define what information is displayed on which devices. In some such embodiments, the user can make a selection via a user interface on any of the test and measurement tool, the imaging tool, or an external device regarding the type and location of displayed data using any of the available devices in communication with the system (e.g., test and measurement tool, imaging tool, external device, etc.).

In some examples, certain combinations may be unavailable for selection by a user. For example, in some instances, a display of the test and measurement tool may be incapable or impractical for presenting display 700. Thus, in some such examples, such a display mode may not be a selectable option. Additionally or alternatively, if only certain display settings (e.g., displaying information on a display of an external device) are practical display modes, such a display mode may be automatically used as a default setting.

Various embodiments have been described. Such examples are non-limiting, and do not define or limit the scope of the invention in any way. Rather, these and other examples are within the scope of the disclosure.

1. A system comprising:
a test and measurement tool configured to acquire measurement data representative of at least one parameter of a device under test;
an imaging tool configured to acquire image data representative of a target scene;
a display device comprising a display and in communication with the test and measurement tool and the imaging tool and configured to receive measurement data from the test and measurement tool, receive image data from the imaging tool, and present a display representative of at least one of the measurement data and image data on the display.

2. The system of claim 1, wherein the imaging tool is integrally attached to the test and measurement tool to form a combination tool, and wherein the display device is separate from the combination tool.

3. The system of claim 2, wherein the display device is in wireless communication with the combination tool.

4. The system of claim 3, wherein the test and measurement tool is capable of measuring at least one parameter from the group consisting of a current and a voltage of a device under test.

5. The system of claim 4, wherein the imaging tool comprises an infrared (IR) sensor array, and wherein the image data comprises IR image data.

6. The system of claim 1, wherein the test and measurement tool is capable of generating measurement data representative of at least one non-electrical parameter of a device under test.

7. The system of claim 1, wherein the imaging tool is removably attachable to the test and measurement tool.

8. The system of claim 7, wherein the display device is integrally attached to the imaging tool, such that the imaging tool includes a built-in display.

9. The system of claim 1, wherein the imaging tool comprises a visible light (VL) sensor array configured to generate VL image data representative of the target scene and an infrared (IR) sensor array configured to generate IR image data representative of the target scene.

10. The system of claim 1, wherein the display device comprises a processor and a non-transitory computer-readable medium containing instructions for causing the processor to combine received measurement data and image data to generate a display comprising both measurement data and image data.

11. The system of claim 10, wherein the display device comprises one of a smartphone, a tablet, a wearable device, or a computer, and the non-transitory computer-readable medium comprises an application (app) for processing data using the display device.

12. The system of claim 11, wherein the display device comprises eyewear, further comprising:
an embedded sensor configured to receive a first set of data representative of a target area;
a wireless radio configured to receive a second set of data from an external device;
one or more lenses proximate a wearer's eye when the wearer is wearing the eyewear;
one or more display surfaces proximate a wearer's eye when the wearer is wearing the eyewear, the one or more display surfaces configured to display at least one of the first and second sets of data; and
a control component configured to permit wearer control of the eyewear.

13. The system of claim 1, wherein the display device comprises a dedicated power supply.

14. The system of claim 1, wherein the test and measurement tool comprises a test and measurement display that is separate from the display tool.

15. A combination tool comprising:
a housing;
a test and measurement portion supported by the housing and configured to generate measurement data representative of at least one parameter of a device under test;
an imaging portion supported by the housing and configured to generate image data representative of a target scene; and
a communication portion configured to output measurement data generated by the test and measurement tool and image data generated by the imaging tool.

16. The combination tool of claim 15, wherein the imaging portion comprises an infrared (IR) sensor array configured to receive IR radiation and to generate IR image data therefrom.

17. The combination tool of claim 15, wherein the communication portion comprises a wireless communication element capable of wirelessly transmitting one or both of the measurement data and the image data to a separate device.

18. The combination tool of claim 15, wherein the imaging portion is removably supported by the housing.

19. The combination tool of claim 15, wherein the test and measurement portion is configured so that the measurement data comprises at least a current or a voltage.

20. The combination tool of claim 15, further comprising a processor configured to combine measurement data and image data, and wherein outputting measurement data and image data comprises outputting the combined measurement and image data.

21. A method comprising:
acquiring measurement data representative of a parameter of an object under test;
acquiring image data representative of a target scene; and
communicating the acquired measurement data and the acquired image data to an external device.

22. The method of claim 21, wherein communicating the acquired measurement data and the acquired image data to the external device comprises wirelessly communicating the data.

23. The method of claim 21, wherein the measurement data comprises a current or a voltage.

24. The method of claim 21, wherein the image data comprises infrared (IR) image data.
